(19) United States
(12) Patent Application Publication
(10) Pub. No.: US 2011/0252894 A1
(43) Pub. Date: Oct. 20, 2011

(54) FENCE JUMPING DETECTION ROD HAVING ELASTICALLY SUPPORTED BALL

(76) Inventor: Dae Jong JUNG, Saha-Gu (KR)

(21) Appl. No.: 13/171,856

(22) Filed: Jun. 29, 2011

Related U.S. Application Data
(63) Continuation of application No. PCT/KR2009/007616, filed on Dec. 19, 2009.

(30) Foreign Application Priority Data
Jan. 9, 2009 (KR) 10-2009-0001853

(51) Int. Cl. G01L 3/00

(52) U.S. Cl. 73/862.325; 73/862.321

(57) ABSTRACT

The object of the present invention is to provide an improved fence jumping detection rod that solves the problem in regard to erroneous alarms caused by unspecified external factors such as approaching animals, strong winds, or the like, and that is capable of quickly restoring to the original state after detection of a fence jumping. To achieve the object, the fence jumping detection rod according to the present invention includes: a support rod having a support portion for supporting a mesh or a line, and a shaft coupling portion extending to the one side of the support portion; a shaft support coupled to the shaft coupling portion via a joint shaft to enable the support rod to move in an arc-like motion; an elastically supported ball allowing the support rod to move in an arc-like motion only when a torque greater than a torque set about the joint shaft is imposed on the shaft coupling portion; and a sensing means for sensing an arc-like motion of the support rod.

### REFERENCE TO RELATED APPLICATIONS

This is a continuation of pending International Patent Application PCT/KR2009/007616 filed on Dec. 19, 2009, which designates the United States and claims priority of Korean Patent Application No. 10-2009-0001853 filed on Jan. 9, 2009.

### FIELD OF THE INVENTION

The present invention relates to a fence jumping detection rod and, more particularly, to a fence jumping detection rod having an elastically supported ball that improves the problem in regard to erroneous alarms caused by external unspecified factors such as approaching animals, strong winds, or the like in a fence protection system.

### BACKGROUND OF THE INVENTION

FIG. 1 is a schematic view of a fence protection device according to prior art.

The fence protection system is used for a variety of purposes such as fence jump protection or the like in military area, correction facility, or other places that require solid security. The conventional fence protection systems include from the simplest one, bared wire, to the complicated security system such as optical cable system or optical network system.

The replacement of the conventional fence protection system with expensive equipment such as an optical cable system is looking to cause a considerable rise of cost. In a place that is strapped for money, the conventional protection system, even the simplest one such as bared wire is still difficult to improve because of more expenses required. Specially, the place using the bared wire as a main fence protection means is expected to confront a lot of costs for improvement.

An addition of sensing devices such as sensors to the conventional fence protection system has been derived to improve the above-mentioned problem but, instead, causes another problem in regard to erroneous alarms due to unspecified external factors such as approaching animals, strong winds, or the like.

### SUMMARY OF THE INVENTION

It is therefore an object of the present invention to provide an improved fence jumping detection rod that solves the problem in regard to erroneous alarms caused by unspecified external factors such as approaching animals, strong winds, or the like in a fence protection system.

It is another object of the present invention to provide a fence jumping detection rod that is capable of rapidly restoring to the original state.

To achieve the objects of the present invention, there is provided a fence jumping detection rod that includes: a support rod having a support portion for supporting a mesh or a line, and a shaft coupling portion extending to the one side of the support portion; a shaft support coupled to the shaft coupling portion via a joint shaft to enable the support rod to move in an arc-like motion; an elastically supported ball allowing the support rod to move in an arc-like motion only when a torque greater than a torque set about the joint shaft is imposed on the shaft coupling portion; and a sensing means for sensing an arc-like motion of the support rod.

The present invention includes a stopping means for stopping a part of the elastically supported ball to impose a resistance force against the arc-like motion of the support rod. Upon the arc-like motion of the support rod, the elastically supported ball overcomes an imposed elastic force and gets off the stopping means.

Preferably, the sensing means includes a cable cutting means for cutting off a cable for fence jumping detection upon an arc-like motion of the support rod.

Preferably, the cutting means includes: a shaft coupling portion cutting cover being attached to the one side of the shaft coupling portion and having an elastically supported ball moving hole allowing the elastically supported ball to move through; a shaft support cutting cover opposing the shaft coupling portion cutting cover and being attached to the one side of the shaft support; and a detection cable cutting hole being separated from the joint shaft at a predetermined distance and going all the way through the shaft coupling portion, the shaft support, the shaft coupling portion cutting cover, and the shaft support cutting cover. The cable cutting means cuts off the detection cable upon relative rotations of the shaft coupling portion cutting cover and the shaft support cutting cover.

In another aspect of the present invention, the sensing means is constructed to sense the arc-like motion of the support rod according to a contact between two electrodes that are in electrical contact with each other.

In the present invention as constructed above, the stopping means is an elastically supported ball stopping cover opposing the shaft coupling portion, being attached to the shaft support, and having an elastically supported ball stopper groove to hold the elastically supported ball. The sensing means includes: an electrode insertion hole being separated from the joint shaft at a predetermined distance and going all the way through the shaft coupling portion, the shaft support, and the elastically supported ball stopping cover; and two electrodes being inserted in the electrode insertion hole. The electrodes electrically contact with each other on a contact surface between the shaft coupling portion and the shaft support, and get electrically separated from each other upon an arc-motion of the support rod at a predetermined angle.

In the present invention, the stopping means is an elastically supported ball stopper groove formed on the shaft support or the shaft coupling portion. The sensing means includes: an electrode insertion hole being separated from the joint shaft at a predetermined distance and going all the way through the shaft coupling portion and the shaft support; and two electrodes being inserted in the electrode insertion hole. The electrodes electrically contact with each other on a contact surface between the shaft coupling portion and the shaft support, and become electrically separated from each other upon an arc-motion of the support rod at a predetermined angle.

According to the present invention, the elastically supported ball and the elastic means exert a force for supporting the fence jumping detection rod having an elastically supported ball, to reduce erroneous alarms caused by unspecified external factors. As an intruder or a jail breaker jumps over a fence, the detection cable is cut off due to the load to turn on the alarm, realizing a secured fence jumping detection effect. Upon the fence jumping detection, a security gap may occur due to the cut-off of the detection cable. But the detection rod can be easily restored to the original state simply by reconnecting or replacing the cut-off portion of the detection cable.

The detection rod that includes two electrodes in electrical contact with each other rather than the detection cable also generates an alarm upon separation of the electrodes to securely implement the fence jumping detection in a convenient way.

After the fence jumping detection, the detection rod may be restored to the original state simply by repositioning the two electrodes to contact with each other. This reduces the maintenance cost and minimizes the security gap.

### BRIEF DESCRIPTION OF THE DRAWINGS

FIG. 1 is an illustration of a fence protection system according to a prior art.

FIG. 2 is an exploded perspective view showing the structure of a fence jumping detection rod having an elastically supported ball according to an embodiment of the present invention.

FIG. 3 is an assembled cross-sectional view showing the structure of the fence jumping detection rod having an elastically supported ball according to the embodiment of the present invention.

FIG. 4 is an assembled cross-sectional view showing the structure of a fence jumping detection rod having an elastically supported ball according to another embodiment of the present invention.

FIG. 5 is an assembled cross-sectional view showing the structure of a fence jumping detection rod having an elastically supported ball according to further another embodiment of the present invention.

FIG. 6 shows a rain protection cover of the fence jumping detection rod with the elastically supported ball under pressure according to the embodiment of the present invention.

FIG. 7 shows a usage example of the fence jumping detection rod having an elastically supported ball according to the present invention.

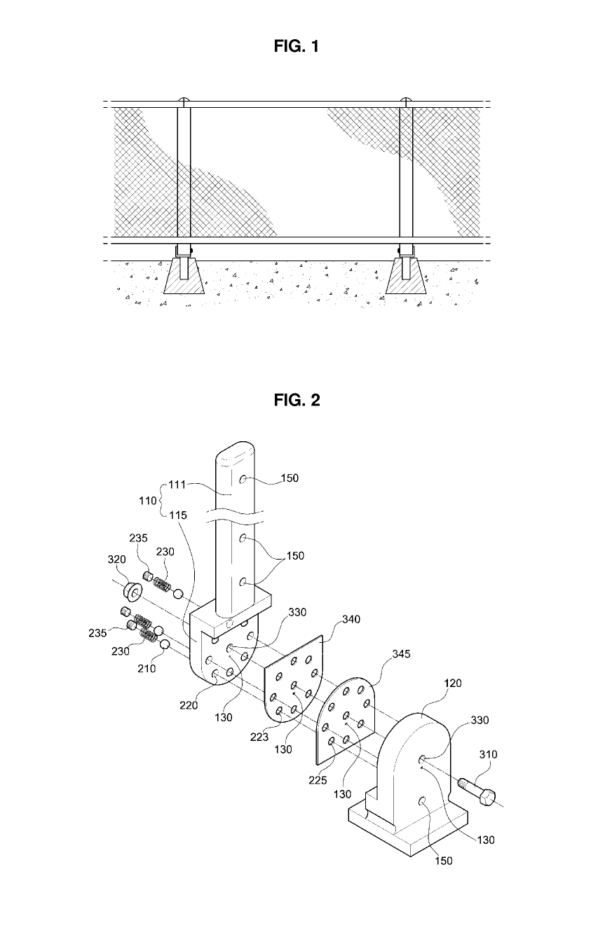

### DETAILED DESCRIPTION OF THE INVENTION

The preferred embodiments of the present invention will be hereafter described in detail, with reference to the accompanying drawings. Throughout the disclosure, like reference numerals refer to like parts throughout the various figures and embodiments of the present invention. Those functions and components that will unnecessarily make the content of the present invention obscure are not described in detail.

FIG. 2 is an exploded perspective showing the structure of a fence jumping detection rod having an elastically supported ball according to an embodiment of the present invention.

Referring to FIG. 2, the fence jumping detection rod of the present invention includes a support rod 110 and a shaft support 120. The support rod 110 includes a support portion 111 supporting a mesh or a line, and a shaft coupling portion 115.

In case that there are installed a plurality of the fence jumping detection rods of the present invention as shown in FIG. 7, the support portion 111 is a part in which a detection mesh, a detection cable, or a wire mesh is installed between the fence jumping detection rods 420. The support portion 111 has at least one mesh support groove 150.

The shaft coupling portion 115 extends from the one side of the support portion 111 and interlocks the shaft support 120.

Into an elastically supported ball receiving hole 220 formed in the one side of the shaft coupling portion 115 are inserted an elastically supported ball 210 and an elastic means 230. Preferably, the elastically supported ball 210 consists of a high-strength material such as steel. This is to prevent potential deformation of the elastically supported ball 210 under the pressure exerted by the elastic means and to maintain the pressure. The elastically supported ball 210 may also consist of a reinforced plastic of an equivalent strength. Preferably, the elastic means 230 is a cylindrical compression spring, in which case a lubricating oil may be used to diminish the fraction on the inside of the elastically supported ball receiving hole 220 against the compression spring.

When a torque greater than a torque set about a joint shaft 310 is imposed on the shaft coupling portion 115, the elastically supported ball 210 overcomes the elastic force of the elastic means 230 and allows the support rod 110 to move in an arc-like motion.

On the one side of the shaft coupling portion 115 opposing the shaft support 120 is attached a shaft coupling portion cutting cover 340. Preferably, the shaft coupling portion cutting cover 340 consists of stainless in order to prevent corrosion such as rust formation. The shaft coupling portion cutting cover 340 has an elastically supported ball moving hole 223 through which the elastically supported ball 210 passes. Likewise, on the one side of the shaft support 120 opposing the shaft coupling portion cutting cover 340 is attached a shaft support cutting cover 345. Preferably, the shaft support cutting cover 345 also consists of stainless in order to prevent corrosion such as rust formation. The one side of the shaft support cutting cover 345 has an elastically supported ball stopper groove 225 that is intended to hold the elastically supported ball 210. In this manner, a part of the elastically supported ball 210 is held in the elastically supported ball stopper groove 225. This interrupts relative arc-like motions of the support rod 110 and the shaft support 120 unless there exists a load greater than a predetermined load value, thereby reducing potential erroneous alarms caused by unspecified external factors such as approaching animals (birds, or the like) or strong winds.

Preferably, an elasticity control bolt 235 is fastened in the elastically supported ball receiving hole 220 to externally increase or decrease the elasticity of the elastic means 230. The turn load of the support rod in an arc-like motion can be determined depending on the number of the elastically supported ball receiving holes 220, or the compressive strength of the elastic means 230 included in the elastically supported ball receiving holes 220.

The number of the elastically supported balls 210 may be less than that of the elastically supported ball moving holes 223. This is because, if necessary, some of the elastically supported balls 210 or the elastic means 230 inserted in the elastically supported ball receiving holes 220 can be removed in order to allow the detection rod to respond to the lighter load. Accordingly, all the elastically supported ball receiving holes 220 are not needed to hold the elastically supported ball 210 and the elastic means 230, and at least one elastically supported ball 210 or elastic means 230 can be used to operate the detection rod.

The shaft support 120 interlocks the shaft coupling portion 115 via the joint shaft 310 inserted in a joint groove 330 in order to enable the support rod 110 to move in an arc-like motion. Preferably, lubricating oil is applied inside the joint groove 330 to reduce friction in the arc-like motion.

The shaft coupling portion 115 has a detection cable cutting hole 130 shaped in a cylindrical form and separated from the joint shaft 310 at a predetermined distance. The detection cable cutting hole 130 is formed to go all the way through the shaft support 120, the shaft coupling portion cutting cover 340, and the shaft support cutting cover 345. Preferably, those respective detection cable cutting holes 130 are in precise alignment with one another in the accurate assembly state. A detection cable is inserted in the detection cable cutting hole 130 and cut off upon relative arc-like motions of the shaft coupling portion cutting cover 340 and the shaft support cutting cover 345 in a misalignment.

For example, at least either one edge of the detection cable cutting holes 130 of the shaft coupling portion cutting cover 340 and the shaft support cutting cover 345 in contact with each other is processed to have a cutting means. The edge may be processed by laser to form a right angle or an acute angle by laser.

When the support rod 110 under a load is put in an arc-like motion about the joint shaft 310, the shaft coupling portion 115 and the shaft coupling portion cutting cover 340 also move arc-likewise integrally. The arc-like motion causes a misalignment of the detection cable cutting holes 130 of the shaft coupling portion cutting cover 340 and the shaft support cutting cover 345 to cut off the detection cable.

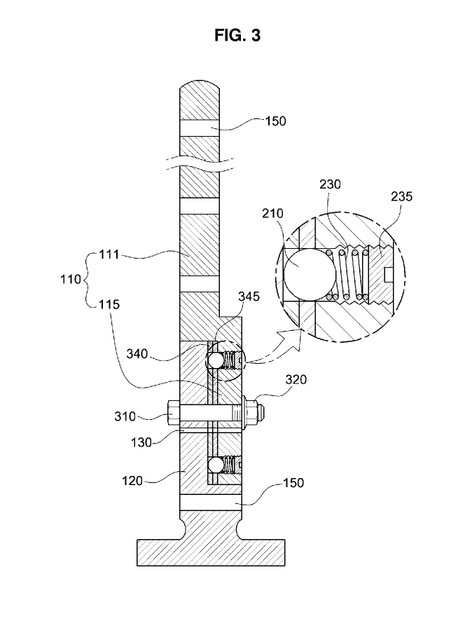

FIG. 3 is an assembled cross-sectional view of the fence jumping detection rod according to the embodiment of the present invention. Referring to FIG. 3, the elasticity control bolt 235 is preferably a cylindrical headless bolt in order to enable the pressure of the elastic means 230 controlled externally with a hex-wrench or a driver.

The shaft support cutting cover 345 needs to be controlled to have an appropriate thickness so that a part of the elastically supported ball 210 is held in the elastically supported ball stopper groove 225. This is to make the elastically supported ball 210 overcome the elastic force and get out of the elastically supported ball stopper groove 225 when a force greater than a predetermined load (or a torque caused by the load) causes the support rod 110 to move in an arc-like motion about the joint shaft 310.

Although the elastically supported ball 210 and the elastic means 230 are provided on the side of the shaft coupling portion 115 in the above-described construction, it is obvious that they can also be on the side of the shaft support 120 to implement the same functions as described above.

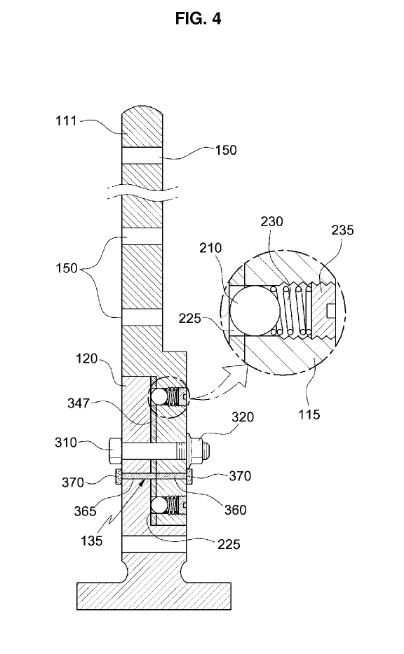

FIG. 4 is an assembled cross-sectional view of a fence jumping detection rod according to another embodiment of the present invention. In this embodiment, there are used two electrodes 360 and 365 that are in electrical contact with each other. The two electrodes 360 and 365 are constructed to get electrically separated from each other upon an arc-like motion of the support rod 110, thereby detecting an intruder's jumping the fence.

Referring to FIG. 4, an elastically supported ball stopper cover 347 is attached to the one side of the shaft support 120 that faces the shaft coupling portion 115. On the one side of the elastically supported ball stopper cover 347 is formed an elastically supported ball stopper groove 225 for partly receiving the elastically supported ball 210.

The shaft coupling portion 115 has an electrode insertion hole 135 separated from the joint shaft at a predetermined distance. The electrode insertion hole 135 is formed to go all the way through the shaft support 120 and the elastically supported ball stopper cover 347. Both the electrode insertion holes 135 in the shaft support 120 and the elastically supported ball stopper cover 347 are in precise alignment with each other in the accurate assembly state.

The electrode insertion holes 135 hold the two electrodes 360 and 365, which can be in electrical contact with each other. The two electrodes 360 and 365 are electrically connected to each other on the contact surface between the elastically supported ball stopper cover 347 and the shaft coupling portion 115, allowing the electrical current to flow. Preferably, the two electrodes 360 and 365 other than an electrical connection portion are coated with an insulating material and subjected to a shielding process in order to prevent potential malfunction caused by external noise.

The two electrodes 360 and 365 are connected to the detection cable via a detection cable connection socket 370 or by soldering. For insulation or prevention of corrosion, silicon may be applied to the detection cable connection socket 370 or the soldered area.

Preferably, the electrodes 360 and 365 are provided in the form of a cylindrical rod consisting of a conductive metal.

In this embodiment, when the support rod 110 under a load (torque) moves in an arc-like motion about the joint shaft 310, the two electrodes 360 and 365 become electrically separated from each other to interrupt the current, turning on the alarm.

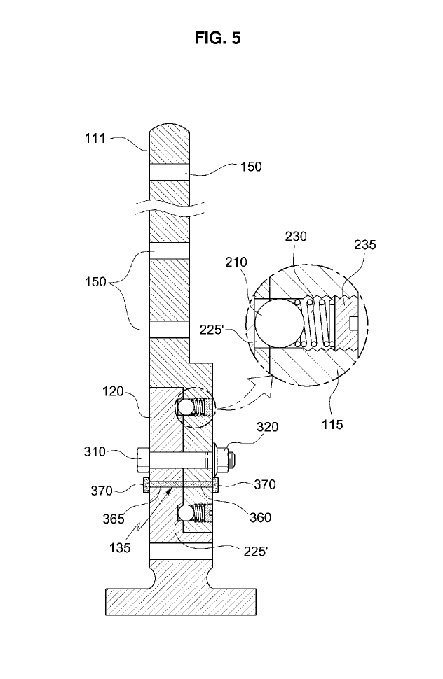

FIG. 5 illustrates a detection rod having the same construction of FIG. 4 excepting that the elastically supported ball stopper cover 347 is not provided.

In FIG. 5, an elastically supported ball stopper groove 225′ is formed in the shaft support 120, while the elastically supported ball stopper groove 225 is provided in the elastically supported ball stopper cover 347 of FIG. 4. The elastically supported ball 210 is held in the elastically supported ball stopper groove 225′ formed in the shaft support 120.

The embodiment of FIG. 5 is the same in operation as the embodiment of FIG. 4 excepting the above-mentioned differences. Alternatively, the construction of FIG. 5 can be altered in a manner that the elastically supported ball stopper groove 225′ is formed in the shaft coupling portion 115 rather than in the shaft support 120 and that the elastically supported ball receiving hole 220 and the elastic means 230 are provided in the shaft support 120.

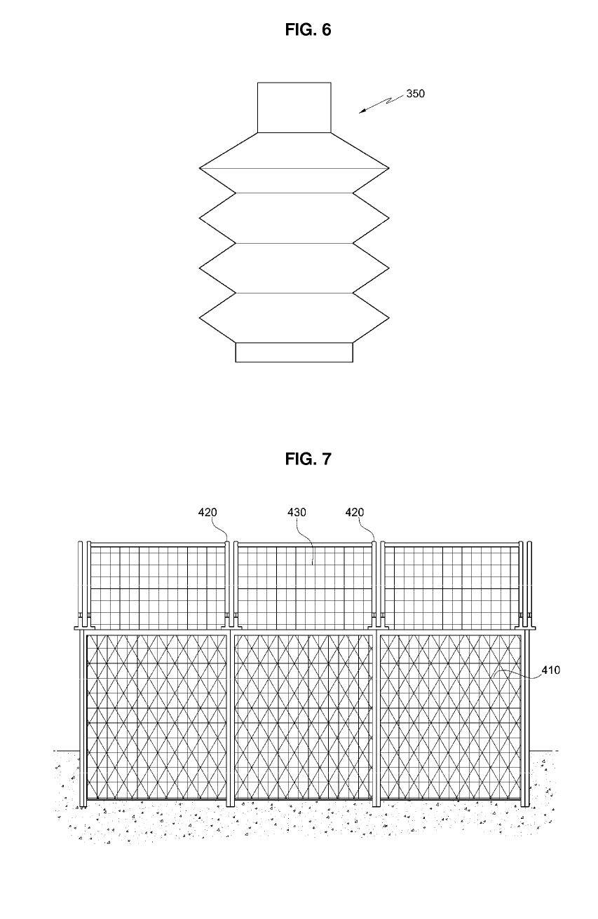

FIG. 6 shows a rain protection cover 350 of the fence jumping detection rod according to the embodiment of the present invention. When exposed to outer circumference, the shaft coupling portion 115 and the shaft support 120 interlocked with each other are susceptible to contamination with rain or other foreign materials. Particularly, in the winter season, the shaft coupling portion 115 and the shaft support 120 in the state of being interlocked with each other are frozen, with a failure to achieve the effect of fence jumping protection. To solve this problem, the rain protection cover 350 is preferably applied on the shaft coupling portion 115 and the shaft support 120. Preferably, the rain protection cover 350 consists of a soft synthetic resin material and is molded into bellows.

FIG. 7 shows a usage example of the fence jumping detection rod of the present invention, in which fence jumping detection rods 420 are installed on the top of a conventional wire mesh 410.

In an attempt to jump over a fence, an intruder grips and climbs the fence jumping detection rod 420 or a detection mesh 430 between the detection rods 420. As the intruder pulls the detection rod 420 or the detection mesh 430, the pulling force causes the support rod 110 to move in an arc-like motion. Upon the arc-like motion of the support rod 110, the detection cable cutting holes 130 formed on the shaft coupling portion 115 and the shaft support 120 become misaligned with each other to cut off the detection cable which is inserted in the detection cable cutting holes 130. The cut-off of the detection cable causes a change in the current signal flowing through the detection cable to turn on the alarm.

In another embodiment, as the intruder's pulling force causes the support rod 110 to move in an arc-like motion, the two electrodes 360 and 365 inserted in the electrode insertion hole 135 become misaligned with each other. This interrupts the current flowing between the two electrodes, and a detection of the current interruption turns on the alarm.

After completion of the fence jumping detection, the system can be restored to the original state simply by reconnecting or replacing the cut-off detection cable of the corresponding fence jumping detection rod 420 generating a detection signal in case of a cut-off of the detection cable, or by relocating the support rod 110 to the original position in case of an interruption of the current due to misalignment of the two electrodes 360 and 365.

The easiness and convenience of restoration results in reduced maintenance costs and minimized security gap.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

The present invention relates to a fence jumping detection rod that can be installed in security facility to prevent an access to the facility by intruders. Due to the secured fence jumping detection effect, the fence jumping detection rod can be widely used in different kinds of areas such as military areas, correctional facilities, or other restricted access areas.

What is claimed is:

1. A fence jumping detection rod comprising:
a support rod having a support portion for supporting a mesh or a line, and a shaft coupling portion extending to the one side of the support portion;
a shaft support coupled to the shaft coupling portion via a joint shaft to enable the support rod to move in an arc-like motion;
an elastically supported ball allowing the support rod to move in an arc-like motion only when a torque greater than a torque set about the joint shaft is imposed on the shaft coupling portion; and
a sensing means for sensing an arc-like motion of the support rod.

2. The fence jumping detection rod as claimed in claim 1, further comprising:
a stopping means for stopping a part of the elastically supported ball to impose a resistance force against the arc-like motion of the support rod,
upon the arc-like motion of the support rod, the elastically supported ball overcoming an elastic force imposed thereon and getting off the stopping means.

3. The fence jumping detection rod as claimed in claim 2, wherein the sensing means includes a cable cutting means for cutting off a cable for fence jumping detection upon an arc-like motion of the support rod.

4. The fence jumping detection rod as claimed in claim 3, wherein the cable cutting means comprises:
a shaft coupling portion cutting cover being attached to the one side of the shaft coupling portion and having an elastically supported ball moving hole allowing the elastically supported ball to move through;
a shaft support cutting cover opposing the shaft coupling portion cutting cover and being attached to the one side of the shaft support; and
a detection cable cutting hole being separated from the joint shaft at a predetermined distance and going all the way through the shaft coupling portion, the shaft support, the shaft coupling portion cutting cover, and the shaft support cutting cover,
the cable cutting means cutting off the detection cable upon relative rotations of the shaft coupling portion cutting cover and the shaft support cutting cover.

5. The fence jumping detection rod as claimed in claim 1, wherein the sensing means senses the arc-like motion of the support rod according to a contact between two electrodes being in electrical contact with each other.

6. The fence jumping detection rod as claimed in claim 2, wherein the stopping means is an elastically supported ball stopping cover opposing the shaft coupling portion, being attached to the shaft support, and having an elastically supported ball stopper groove to hold the elastically supported ball, the sensing means comprising:
an electrode insertion hole being separated from the joint shaft at a predetermined distance and going all the way through the shaft coupling portion, the shaft support, and the elastically supported ball stopping cover; and
two electrodes being inserted in the electrode insertion hole,
the electrodes being in electrical contact with each other on a contact surface between the elastically supported ball stopping cover and the shaft coupling portion, and getting out of the electrical contact upon an arc-motion of the support rod at a predetermined angle.

7. The fence jumping detection rod as claimed in claim 2, wherein the stopping means is an elastically supported ball stopper groove formed on the shaft support or the shaft coupling portion,
the sensing means comprising:
an electrode insertion hole being separated from the joint shaft at a predetermined distance and going all the way through the shaft coupling portion and the shaft support; and
two electrodes being inserted in the electrode insertion hole,
the electrodes being in electrical contact with each other on a contact surface between the shaft coupling portion and the shaft support, and getting out of the electrical contact upon an arc-motion of the support rod at a predetermined angle.
